(19) United States
(12) Patent Application Publication
(10) Pub. No.: US 2015/0097024 A1
(43) Pub. Date: Apr. 9, 2015

(54) ELECTRODE FORMING DEVICE, ELECTRODE FORMING SYSTEM AND ELECTRODE FORMING METHOD

(71) Applicant: Hitachi, Ltd., Tokyo (JP)

(72) Inventors: Hirokuni KURIHARA, Tokyo (JP); Akio IGARASHI, Tokyo (JP); Ryosuke MIZUTORI, Tokyo (JP); Akinori GOWA, Tokyo (JP); Naoaki HASHIMOTO, Tokyo (JP)

(73) Assignee: Hitachi, Ltd.

(21) Appl. No.: 14/504,582

(22) Filed: Oct. 2, 2014

(30) Foreign Application Priority Data
Oct. 3, 2013 (JP) 2013-208473

(51) Int. Cl. B23K 1/20; B23K 3/06; B23K 37/04; B23K 3/08

(52) U.S. Cl. CPC B23K 1/203; B23K 3/082; B23K 3/0623; B23K 37/04; B23K 2201/36
USPC 228/223; 228/41

(57) ABSTRACT

An electrode forming device has a pressing unit that presses a substrate on a printing table from above, a suction unit that sucks the substrate on the printing table, a mask member integrally formed with a first mask section used for applying flux on the substrate and a second mask section used for filling a conductive ball on the substrate applied with the flux, a squeegee head that applies the flux via the first mask section, an air cylinder that moves the mask member, and a filling head that fills a conductive ball via the second mask section.

### CROSS REFERENCE TO RELATED APPLICATION

The present application claims benefit of the filing date of Japanese Patent Application No. 2013-208473 filed on Oct. 3, 2013, the disclosure of which is incorporated herein by reference.

### BACKGROUND OF THE INVENTION

1. Field of the Invention

The invention relates to an electrode forming device which forms electrodes on a substrate, an electrode forming system and an electrode forming method.

2. Description of the Related Art

Surface-mounted electronic components such as a BGA (Ball Grid Array) and a CSP (Chip Size Package) are mounted in computers, cellular phones, digital appliances and the like. A number of electrodes (bumps) formed in a hemisphere shape are provided on a rear surface of the surface-mounted electronic component. Thus, the number of contacts on the substrate can be increased by providing the electrodes on the rear surface of the electronic component. This makes a mounting area of the electronic component smaller and realizes downsizing and densification thereof.

A number of electrodes (bumps) are formed on points corresponding to electrodes of the electronic components on the substrate where the surface-mounted electronic components are mounted. At first, flux is applied on the substrate via a mask for flux application having a number of bores therein. Then, conductive balls are filled on the flux mentioned above via a mask for conductive ball filling having a number of bores therein.

For example, JP4933367B discloses a flux application device which applies the flux on a wafer and a ball filling device which fills the conductive balls on the wafer applied with the flux thereon.

### SUMMARY OF THE INVENTION

When the flux is applied and the conductive balls are filled, the substrate is preferably positioned to closely contact on a printing table.

The substrate on which the surface-mounted electronic components are mounted is often molded with resin for protecting IC chips. In case that such a substrate is used, the substrate may deform in a bent state due to shrinkage of the resin associated with drying. In case that the substrate deforms like this, it is difficult to closely contact the substrate on the printing table only by vacuum suction because the substrate has comparatively high rigidity.

The above-mentioned JP4933367B discloses one ball filling device which is arranged at a downstream side of a flux application device. In such a structure, it is conceivable that, for example, the substrate is pressed on the printing table by a pressing plate and is sucked in vacuum, and the flux is applied on the substrate while the vacuum suction is maintained.

However, with the structure disclosed in JP4933367B, when the substrate is conveyed to the ball filling device at the downstream side after the flux has been applied, the vacuum suction described above is compelled to be once released.

After the vacuum suction is released, even if a user tries to closely contact the substrate on the printing table again in a ball printer, the substrate cannot be pressed on the printing table by the pressing plate from this state. This is because that the flux has been already applied on an upper surface of the substrate.

In JP4933367B, the substrate cannot be closely contacted on the printing table in the ball filling device and the substrate may not be positioned correctly. Then, the conductive balls cannot be filled on desired points, and a yield rate of an electrode forming process on the substrate lowers. This tendency is more remarkable as a diameter or a pitch of the conductive ball becomes smaller.

Therefore, the invention provides an electrode forming device which improves a yield rate of an electrode forming process on a substrate, an electrode forming system and an electrode forming method.

In order to solve the problem, an aspect of an electrode forming device according to the invention has a pressing unit that presses a substrate on a printing table from above; a suction unit that sucks the substrate pressed by the pressing unit on the printing table and continues to suck the substrate after the pressing unit is released; a mask member that has a first mask section used for applying flux on the substrate and a second mask section used for filling a conductive ball on the substrate applied with the flux, the first mask section and the second mask section being connected to each other or being integrally formed; a squeegee head that applies the flux via the first mask section on the substrate sucked by the suction unit; a mask member moving unit that moves the mask member to adjust a relative position of the mask member to the substrate; and a filling head that fills a conductive ball via the second mask section of the mask member to form an electrode on the substrate sucked by the suction unit.

Details thereof will be explained in a detailed description of the preferred embodiments later.

According to the invention, it is possible to provide an electrode forming device which improves a yield rate of an electrode forming process on a substrate, an electrode forming system and an electrode forming method.

### BRIEF DESCRIPTION OF THE DRAWINGS

FIG. 1 is a schematic plan view illustrating a structure including an electrode forming device according to a first embodiment of the invention, a loader and an inspection/repair device;

FIG. 2 is a cross sectional view seen from an A-A line in FIG. 1;

FIG. 3 is a schematic plan view of a mask member;

FIG. 4 is an end view seen from a B-B line in FIG. 2;

FIG. 5 is a plan view of the electrode forming device;

FIG. 6 is an end view (in a state that a filling head is arranged right above a substrate) seen from a C-C line in FIG. 2;

FIG. 7 is a flowchart illustrating operations of the electrode forming device;

FIGS. 8A to 8E are schematic cross sectional views which illustrate the operations of the electrode forming device in chronological order from FIGS. 8A to 8E; and

FIG. 9 is a schematic plan view illustrating a structure including an electrode forming device according to a second embodiment of the invention.

### DETAILED DESCRIPTION OF THE PREFERRED EMBODIMENTS

### First Embodiment

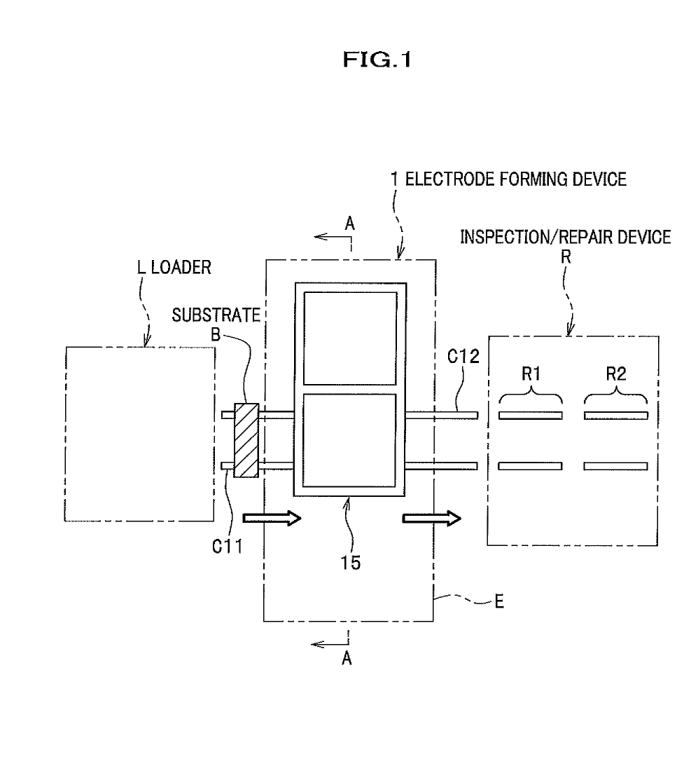

FIG. 1 is a schematic plan view illustrating a structure including an electrode forming device according to an embodiment, a loader and an inspection/repair device. Only a casing E and a mask member 15 are schematically illustrated in the electrode forming device 1 in FIG. 1.

The electrode forming device 1 is a device which applies flux on upper surfaces of substrates B supplied from a loader L one by one and fills conductive balls at points where the flux has been applied.

The substrate B is a plate-shaped member on which chips or the like cutout from a wafer are mounted, and, for example, is molded with resin. Such a substrate B often deforms (bends upward) when the resin dries and shrinks.

The flux is applied on the substrate B to fix the conductive balls by adhesion force thereof and to eliminate oxides from pads as an upper surface of the substrate or upper surfaces of the conductive balls. The conductive balls are, for example, soldering balls having a diameter about 0.05 mm to 0.3 mm and are filled on the above-mentioned flux.

A loader L arranged at an upstream side of the electrode forming device 1 accommodates a number of substrates B. The loader L is a device which supplies the substrates B one by one on an import conveyor C11 whenever the substrate B is processed by the electrode forming device 1.

The import conveyor C11 is a device which conveys the substrate B supplied from the loader L in the electrode forming device 1. An export conveyor C12 is a device which conveys the substrate B processed by the electrode forming device 1 to the inspection/repair device R.

### [Structure of the Electrode Forming Device]

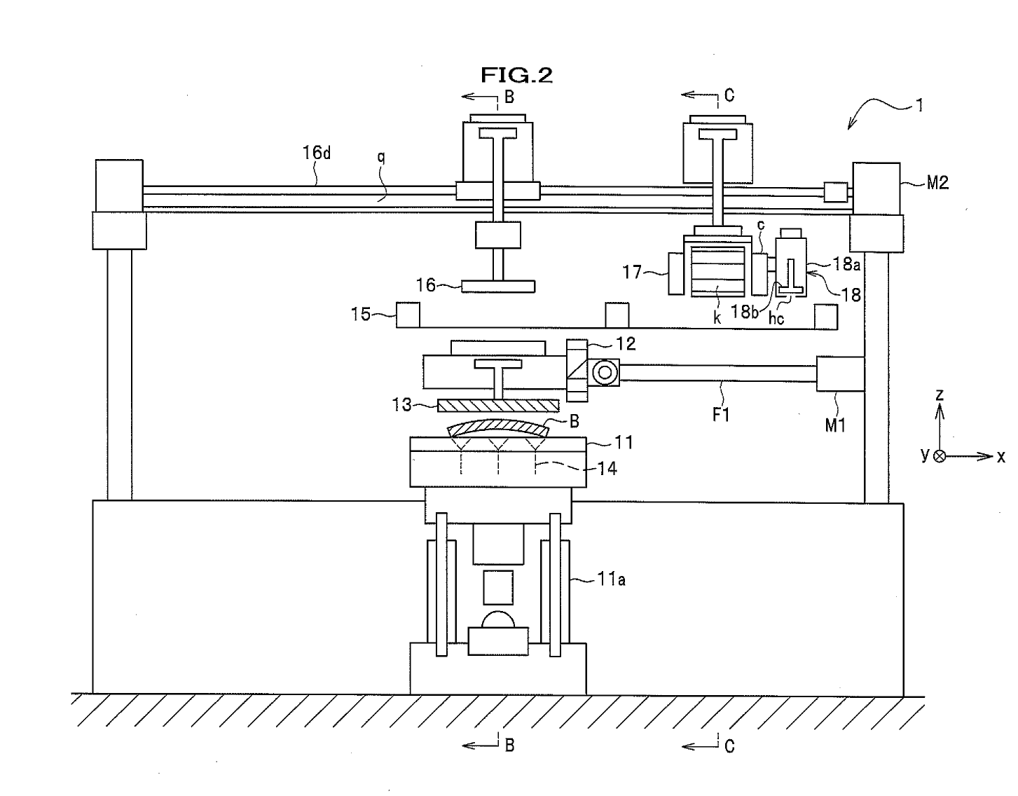

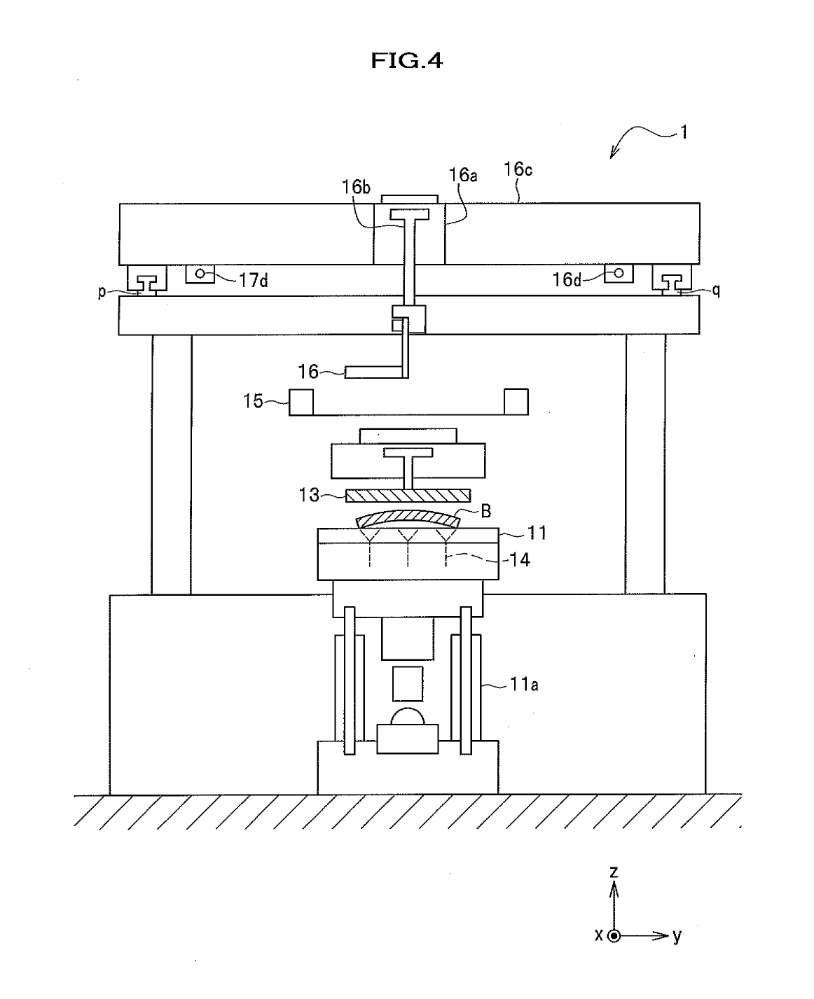

FIG. 2 is a cross sectional view seen from an A-A line in FIG. 1. In FIG. 2, the casing E accommodating the import conveyor C11, the export conveyor C12 and the electrode forming device 1 is not illustrated, and the deformation of the substrate B is emphasized (the same also applies to FIGS. 5, 4 and 6).

The electrode forming device 1 has a printing table 11, a camera 12, a pressing plate 13, a suction device 14, a mask member 15, a squeegee head 16, a filling head 17, an air cylinder 18 and a controller (not shown) controlling these parts.

The printing table 11 is a device which adjusts a position of the substrate B in an X-direction, a Y-direction and a θ-direction (rotation on an X-Y plane) illustrated in FIG. 2. Further, the printing table 11 has a function by which the printing table 11 is moved by an elevating mechanism 11a in a Z-direction (vertical direction) to closely contact the substrate B on the mask member 15 and to separate the substrate B from the mask member 15.

A table conveyor (not shown) is provided on the printing table 11. The table conveyor has a function by which the table conveyor receives the substrate B from the import conveyor C11 (see FIG. 1) and conveys the substrate B to a predetermined position (where the substrate B is temporarily positioned).

The camera 12 is a two-view camera which can image an upper side and a lower side thereof. The camera 12 is configured to be capable of moving in the X-direction along a ball screw F1 in accordance with activation of a motor M1 and to be capable of moving in the Y-direction along another frame (not shown).

The camera 12 images an alignment mark (not shown) printed on a lower surface of the mask member 15 and an alignment mark (not shown) printed on the upper surface of the substrate B respectively to output the alignment marks to the controller (not shown). The controller executes an imaging process based on the imaged result and adjusts the position of the printing table 11 to cancel a positional displacement amount of the substrate B.

The pressing plate 13 is a plate-shaped member which closely contacts the substrate B on the printing table 11 and is pressed on the substrate B from above before the flux is applied thereon. The pressing plate 13 is, for example, a resin plate having a rectangular shape in planar view and extends along a horizontal surface. The pressing plate 13 is configured to be capable of moving in the Z-direction (vertical direction) and is connected to the above-mentioned camera 12.

When the camera 12 is moved in the X-Y direction by the motor M1 or the like, the pressing plate 13 also moves in the X-Y plane in accordance with the movement of the camera 12.

In other words, a “camera moving unit” which moves the camera 12 used for aligning the mask member 15 and the substrate B is structured to include the motor M1 and the ball screw F1. The “camera moving unit” also moves the pressing plate 13 in addition to the camera 12 as described above.

The suction device 14 (suction unit) is a device which sucks the substrate B pressed by the pressing plate 13 on the printing table 11. Shortly, the suction device 14 has a function by which the substrate B is sucked in vacuum from a lower side via bores (not shown) formed in the printing table 11.

As mentioned above, the substrate B molded with resin often deforms (in a bent state). The suction device 14 begins to suck the substrate B while the substrate B is being pressed by the pressing plate 13 on the printing table 11 and continues to suck the substrate B. Thus, the substrate B can be maintained to closely contact on the printing table 11 even after the pressing plate 13 is released.

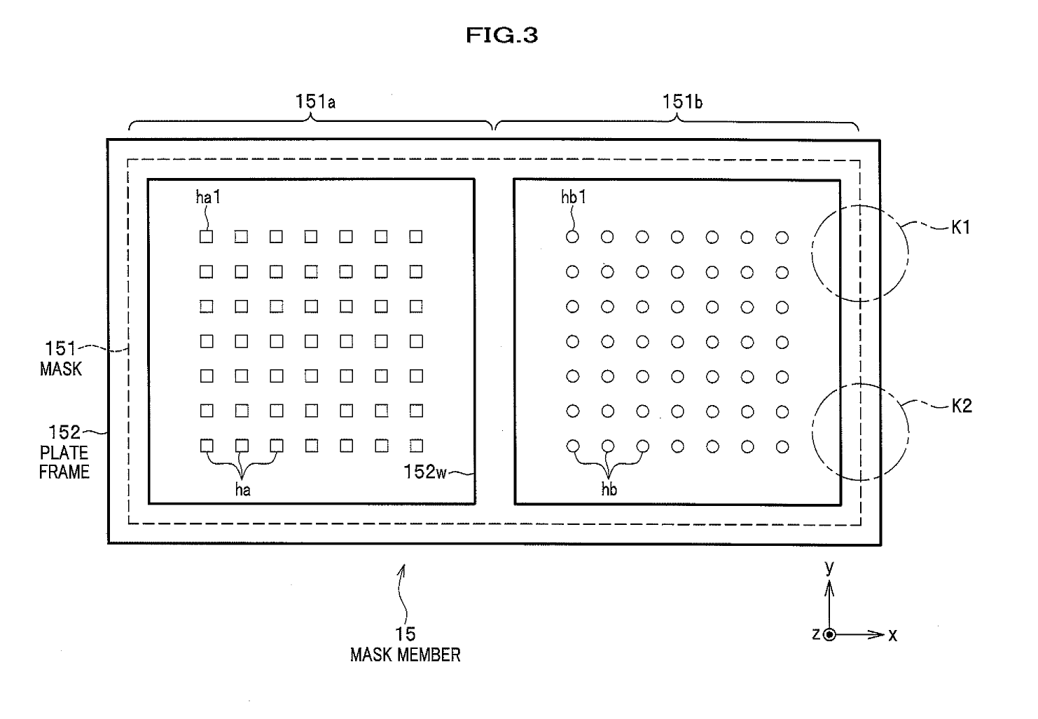

FIG. 3 is a schematic plan view of the mask member. To understand easily, the number of bores ha, hb formed in the mask member 15 is depicted fewer than the actual number of bores, and the bores ha, hb are depicted larger than the actual bores.

The mask member 15 has a mask 151 which has a rectangular shape in planar view and a plate frame 152 which fixes the mask 151. One characteristic of the electrode forming device 1 according to the embodiment is to use the mask 151 to apply the flux and to fill the conductive balls sequentially.

The mask 151 illustrated in FIG. 3 is, for example, a metal mask and has a first mask section 151a for flux application and a second mask section 151b for ball filling.

The first mask section 151a has a plurality of bores ha used for applying the flux on the substrate B corresponding to a circuit pattern of the substrate B. The second mask section 151b has a plurality of bores hb used for filling the conductive balls on the substrate B corresponding to the circuit pattern of the substrate B.

The positions of the bores hb formed in the second mask section 151b correspond to the positions of bores ha formed in the first mask section 151a, respectively. For example, the bore hb1 in the second mask section 151b correspond to the bore ha1 in the first mask section 151a. Though the detail thereof will be explained later, the conductive ball is dropped via the bore hb1 on the flux which is applied on the substrate B via the bore ha1.

The plate frame 152 is a frame which fixes a periphery of the mask 151 provided along the horizontal surface and partitions the first mask section 151a from the second mask section 151b. A partitioning wall 152w which extends in an up-down direction in FIG. 3 of the plate frame 152 partitions the first mask section 151a from the second mask section 151b. The flux having adhesion property can be prevented from being mixed with the conductive balls in a spherical shape (in powder).

Regions circled by K1, K2 in FIG. 3 indicate regions to be sucked by the air cylinder 18 (see FIG. 2) described later.

FIG. 4 is an end view seen from a B-B line in FIG. 2.

The squeegee head 16 is a device which applies the flux on the substrate B sucked by the suction device 14 (in other words, a paddle for applying the flux). When the squeegee head 16 is swept on the first mask section 151a, the flux is pushed out via the bores ha in the first mask section 151a (see FIG. 3) and is applied on the substrate B. The squeegee head 16 is configured to be capable of moving in the Z-direction by a piston 16b operating in a cylinder 16a.

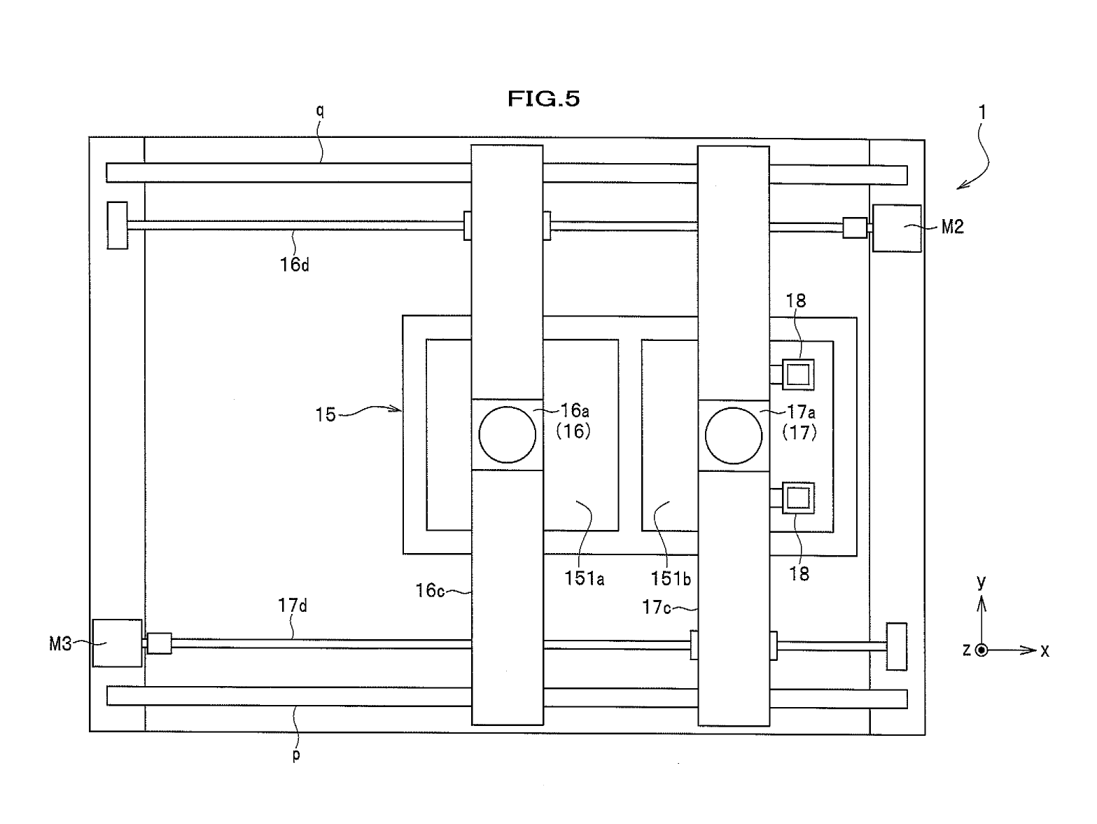

A structure of the squeegee head 16 is not limited to an example illustrated in FIG. 5.

FIG. 5 is a plan view of the electrode forming device.

The squeegee head 16 is provided in a casing 16c which extends in the Y-direction and moves with the casing 16c in the X-direction when a ball screw shaft 16d is rotated by a motor M2. As illustrated in FIGS. 4 and 5, the casing 16c is guided by two-rowed guide rails p, q in the X-direction. Further, the squeegee head 16 can move in the Y-direction along which the casing 16c extends.

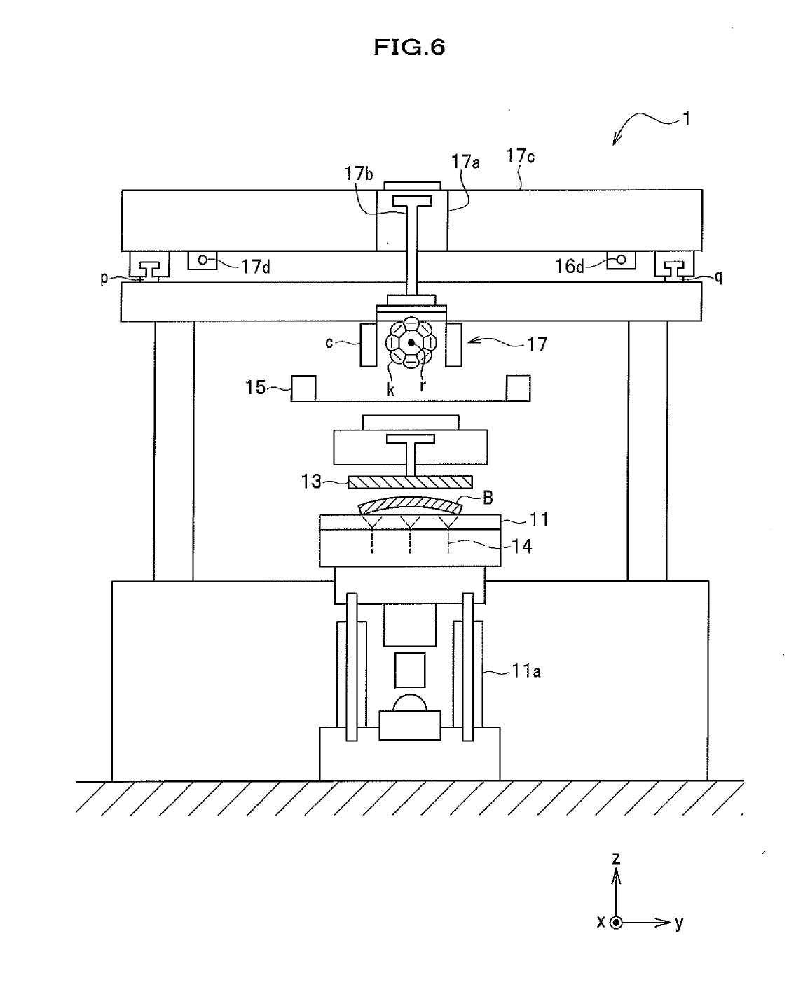

FIG. 6 is an end view seen from a C-C line in FIG. 2. FIG. 6 illustrates that the filling head 17 is arranged right above the substrate B.

The filling head 17 is a device which fills the conductive balls on the substrate B sucked by the suction device 14. The filling head 17 has, for example, a plurality of squeegees k (eight in FIG. 6) fixed on a shaft r and a cover c which accommodates the squeegees k.

When the above-mentioned shaft r is rotated, the conductive balls present in the cover c drop via bores hb in the second mask section 151b (see FIG. 3) to be filled on the substrate. The filling head 17 is configured to be capable of moving in the Z-direction by a piston 17b operating in a cylinder 17a.

A structure of the filling head 17 is not limited to the example in FIG. 6.

As illustrated in FIG. 5, the filling head 17 is accommodated in a casing 17c which extends in the Y-direction, and moves with the casing 17c in the X-direction when a ball screw shaft 17d is rotated by a motor M3. As illustrated in FIGS. 5 and 6, the casing 17c is guided by the two-rowed guide rails p, q in the X-direction. Further, the filling head 17 can move in the Y-direction along which the casing 17c extends.

A “head moving unit” which moves the head as the squeegee head 26 or the filling head 17 is structured to include the motor M3, the ball screw shaft 17d and the guide rails p, q illustrated in FIG. 5.

The air cylinder 18 (relative position fixing unit) illustrated in FIG. 2 sucks one end (regions illustrated by K1, K2 in FIG. 3) of the plate frame 152 by negative pressure and fixes a relative position of the mask member 15 and the filling head 17.

The air cylinder 18 has a rod cover 18a, a piston rod 18b accommodated in the rod cover 18a and a pressure generation mechanism (not shown) which generates/releases the negative pressure by reciprocating the piston rod 18b.

When the negative pressure is applied on the plate frame 152 via a bore he formed at a tip end of the rod cover 18a, the plate frame 152 is sucked on the air cylinder 18. In the example illustrated in FIG. 5, the two air cylinders 18 are provided which are arranged in parallel in the Y-direction.

The air cylinders 18 are, for example, connected to the cover c of the filling head 17. Therefore, when the filling head 17 is moved in the X-direction by the motor M3 (see FIG. 5), the air cylinders 18 also move in the X-direction in accordance with the movement of the filling head 17. Further, the mask member 15 (see FIG. 3) sucked by the air cylinders 18 also moves in the X-direction.

A “mask member moving unit” which adjusts the relative position of the mask member 15 to the substrate B by moving the mask member 15 is structured to include the motor M3, the ball screw shaft 17d, the guide rails p, q (head moving unit) and the air cylinders 18 (relative position fixing unit).

The controller (not shown) executes positional adjustment of the substrate B based on input signals from the camera 12 (see FIG. 2), pressing on the substrate B by the pressing plate 13, activation of the squeegee head 16 and the filling head 17 and the like.

The controller is configured to include a CPU (Central Processing Unit), a ROM (Read Only Memory), a RAM (Random Access Memory), and electronic circuits (not shown) such as various interfaces to execute various processes based on set programs.

As illustrated in FIG. 1, the inspection/repair device R having an inspection unit R1 and a repair unit R2 is provided at a downstream side of the electrode forming device 1. The inspection unit R1 is a device which inspects whether the conductive balls are filled on predetermined points in the substrate B. The repair unit R2 is a device which refills the conductive balls based on the inspection result by the inspection unit R1.

### <Operation of the Electrode Forming Device>

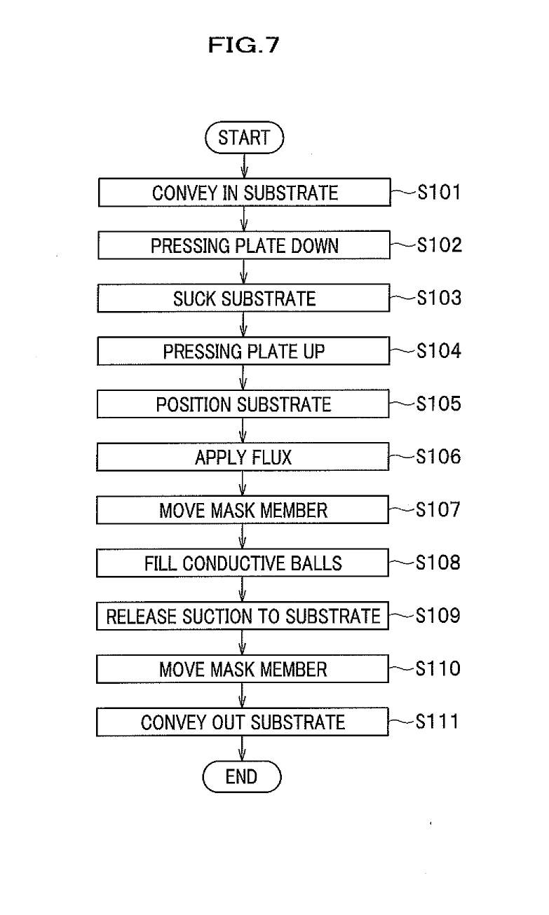

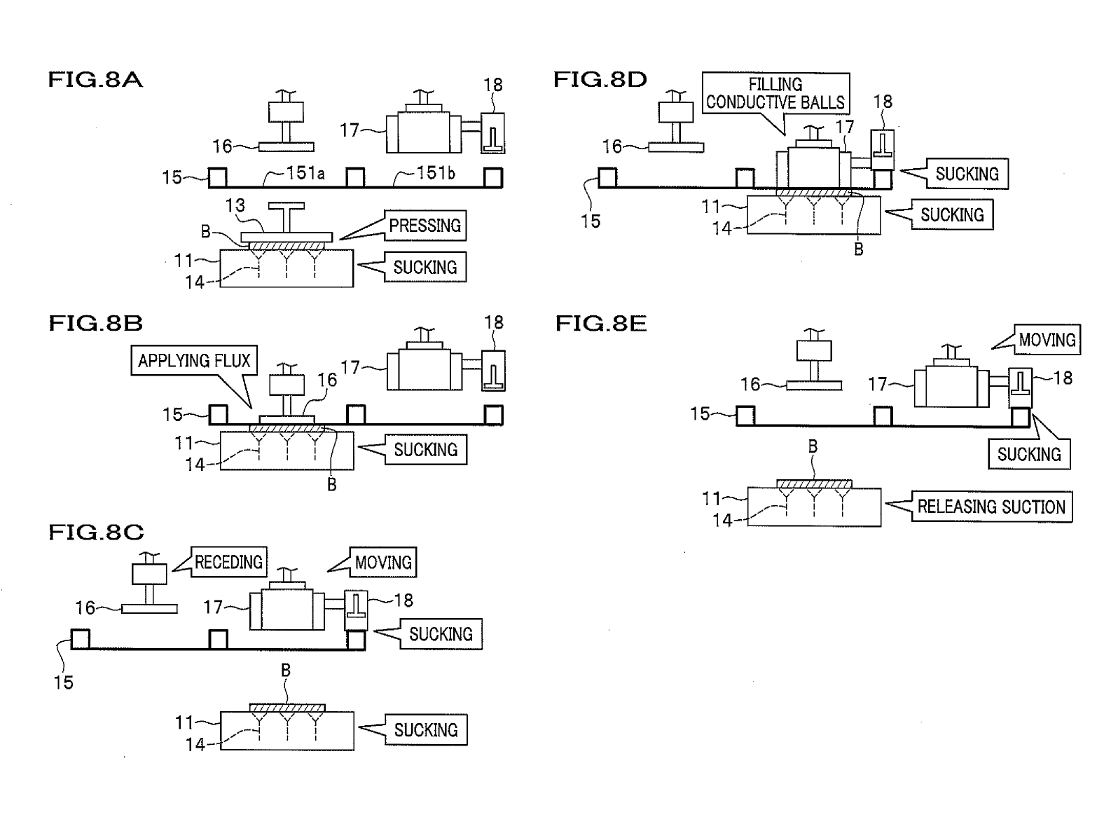

FIG. 7 is a flowchart showing operations of the electrode forming device. FIGS. 8A to 8E are schematic cross sectional views showing the operations of the electrode forming device in chronological order from FIGS. 8A to 8E.

At the “START” in FIG. 7, the first mask section 151a (see FIG. 3) for flux application is provided right above the printing table 11.

In step S101, the controller controls such that the substrate B conveyed from the loader L by the import conveyor C11 (see FIG. 1) is received by the table conveyor (not shown) and is moved to a predetermined position.

In step S102, the controller brings the pressing plate 13 down to press the substrate B on the printing table 11 (pressing process: see FIG. 8A). The controller activates the motor M1 (see FIG. 2) and moves the pressing plate 13 right above the substrate B on the X-Y plane along the ball screw F1 and the like. As described above, since the pressing plate 13 is connected to the camera 12, the camera 12 also moves with the pressing plate 13 on the X-Y plane.

Further, the controller brings the pressing plate 13 down to press on the printing table 11 (for surface contact), and the substrate B closely contacts on the printing table 11. As described above, though the substrate B molded with resin often deforms, the substrate B can be closely contacted on the printing table 11 by this process.

In step S103, the controller activates the suction device 14 to suck the substrate B in vacuum from a lower side (suction process: see FIG. 8A). The pressing on the substrate B by the pressing plate 13 continues during the process in step S103. Therefore, even if the substrate B deforms and curves, there is little space between the substrate B and the printing table 11 (being in close contact with each other). Thus, the substrate B can be sucked in vacuum by the suction device 14 properly.

In step S104, the controller brings the pressing plate 13 up to release the pressing on the substrate B. The suction to the substrate B by the suction device 14 continues even after the pressing plate 13 is released (the suction device 14 is released in step S109 described later for the first time).

As described above, since the vacuum suction begins while the substrate B is being pressed on the printing table 11, the substrate B can be maintained in a close contact on the printing table 11 even after the pressing plate 13 is released.

In step S105, the controller positions the substrate B in the X-Y-θ direction with the use of the printing table 11. The process is executed by moving the printing table 11 such as to cancel a positional displacement amount calculated with the imaged result of the camera 12 (see FIG. 2).

Since the imaging is performed in the state that the substrate B closely contacts on the printing table 11 in the processes in steps S102 and S103, even the substrate B deformed due to drying or the like can be positioned in high accuracy.

In step S106, the controller executes an application process of flux (flux application process: see FIG. 8B). In other words, the controller brings the printing table 11 up by the elevating mechanism 11a (see FIG. 2) and makes the upper surface of the substrate B closely contact on the lower surface of the first mask section 151a (see FIG. 3). In this state, the squeegee head 16 applies the flux on the substrate B, and the controller brings the printing table 11 down by the elevating mechanism 11a to separate the substrate B from the mask member 15.

The flux application is executed after the camera 12 and the pressing plate 13 are receded (see FIG. 8B).

In step S107, the controller moves the mask member 15 in the X-direction such that the second mask section 151b used for filling the conductive balls positions right above the substrate B (positional adjustment process: see FIG. 8C). Shortly, the controller makes the air cylinders 18 suck the plate frame 152 and activates the motor M3 (see FIG. 5) to move the mask member 15 in the X-direction.

At this time, the squeegee head 16 is receded beforehand (or in synchronization with the movement of the filling head 17) so as not to interfere with the filling head 17.

In step S108, the controller makes the filling head 17 fill the conductive balls on the substrate B via the second mask section 151b (ball filling process: see FIG. 8D). Shortly, the controller brings the printing table 11 up by the elevating mechanism 11a (see FIG. 2) to closely contact the upper surface of the substrate B on the lower surface of the second mask section 151b (see FIG. 3). In this state, the controller makes the filling head 17 fill the conductive balls on the substrate B.

Since the first mask section 151a is partitioned from the second mask section 151b by the partitioning wall 152w (see FIG. 3), the conductive balls cannot mix with the flux. After the conductive balls are filled on the substrate B, the controller brings the printing table 11 down by the elevating mechanism 11a (see FIG. 2) to separate the substrate B from the mask member 15 (see FIG. 8E).

In step S109, the controller releases the suction on the substrate B by the suction device 14 (see FIG. 8E). Thus, the negative pressure affecting from the lower side of the substrate B is released and the substrate B can be conveyed by the table conveyor (not shown).

In step S110, the controller moves the mask member 15 such that the first mask section 151a for flux application positions right above the substrate B (see FIG. 8A). Shortly, the controller returns the mask member 15 to the position at the “START” in FIG. 4. Thus, the substrate B to be conveyed at the next time from the upstream side can be applied with the flux smoothly.

In step S111, the controller conveys the substrate B to the downstream side by the export conveyor C12 (see FIG. 1).

The inspection unit R1 of the inspection/repair device R (see FIG. 1) inspects a surface state of the substrate B conveyed from the electrode forming device 1. In case that the conductive balls are not filled on predetermined points corresponding to the circuit pattern of the substrate B, the inspection/repair device R executes a repair process of the conductive balls by the repair unit R2.

The substrate B executed with the inspection/repair process is further executed with a heat treatment in a reflow device (not shown) at the downstream side. Consequently, the conductive balls filled on the substrate B are dissolved and are performed with interface bonding.

### <Effect>

According to the electrode forming device 1 of the embodiment, the flux application and the conductive ball filling can be performed sequentially while the substrate B is kept to closely contact on the printing table 11 by the suction device 14.

As described above, when the suction to the substrate B is once released after the flux is applied, it is difficult to closely contact the substrate B on the printing table 11 again due to reasons below.
(1) Since the flux has already been applied on the upper surface of the substrate B, it is impossible to press the pressing plate 13 on the upper surface of the substrate B again.
(2) Air may flow in the suction device 14 via a gap between the deformed substrate B and the printing table 11. In this case, the substrate B cannot be sucked in vacuum properly and positioning accuracy of the substrate B is lowered.

In this embodiment, the flux application and the conductive ball filling is executed sequentially while the substrate B is sucked by the suction device 14. Therefore, when the relative position of the substrate B and the mask member 15 is adjusted by the printing table 11, it is possible to decrease the positional displacement associated with the deformation of the substrate B and to position the substrate B in high accuracy. Consequently, a yield rate during the process of the substrate B can be greatly improved than before.

Further, in the embodiment, the mask member 15 is structured by the integrally formed first mask section 151a for flux printing with the second mask section 151b for conductive ball filling. Thus, the electrode forming device 1 can be formed smaller, and the electrode forming device 1 needs only a half installation space compared with a case where a flux printer and a ball printer are installed separately.

Still further, the pressing plate 13 is configured to be capable of moving by the motor M1 and the like (see FIG. 2) which move the camera 12 on the X-Y planar surface. Moreover, the air cylinder 18 is configured to be capable of moving by the motor M3 and the like (see FIG. 5) which move the filling head 17. Thus, the number of parts of the electrode forming device 1 can be decreased and manufacturing cost of the electrode forming device 1 can be reduced.

### Second Embodiment

A second embodiment differs from the first embodiment in that an electrode forming device 1A having a bypass conveyor C13 is arranged with an electrode forming device 1B having a bypass conveyor C23 in series, and an electrode forming system S has conveyor devices 31, 32 and 33. Accordingly, the different portions will be explained and the overlapped portions with the first embodiment will be omitted.

### <Structure of the Electrode Forming System>

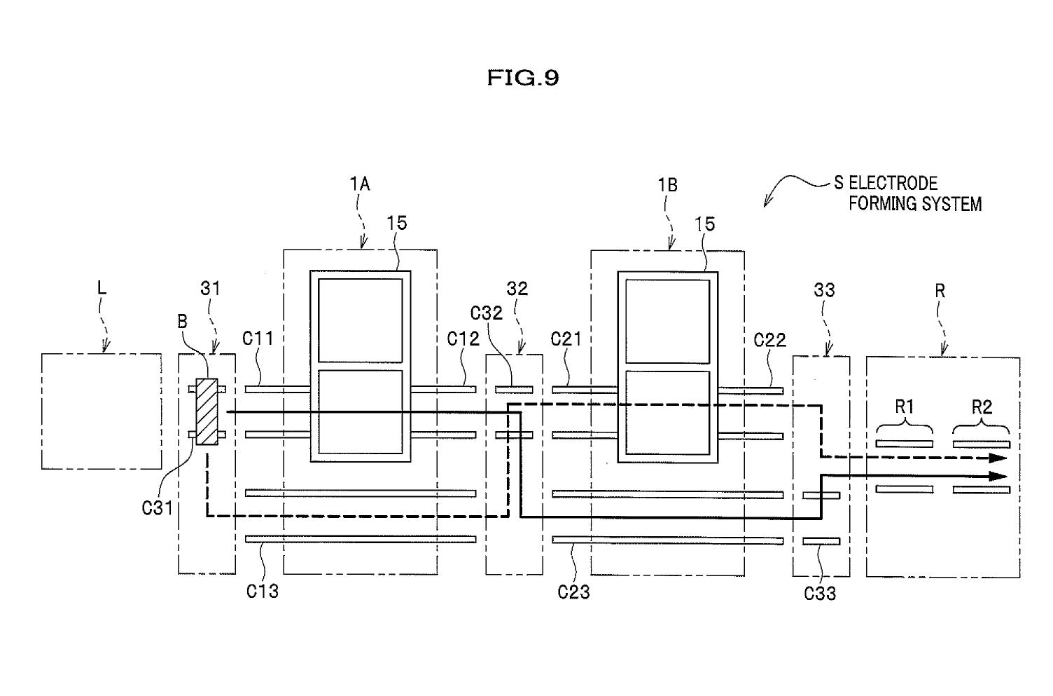

FIG. 9 is a schematic structure (plan) view including electrode forming devices according to the embodiment. An arrow indicated by a thick line and an arrow indicated by a broken line in FIG. 9 indicate paths on which the substrates B are conveyed respectively. The electrode forming system S has the loader L, the conveyor device 31, the electrode forming device 1A, the conveyor device 32, the electrode forming device 1B, the conveyor device 33, and the inspection/repair device R in the order from an upstream side (left side in FIG. 9).

The loader L and the inspection/repair device R are the same as those in the first embodiment, and the explanation thereof will be omitted. The electrode forming devices 1A, 1B has the same structure as the electrode forming device 1 (see FIG. 1) in the first embodiment except the bypass conveyor C13, C23.

The bypass conveyor C13 is a device on which the substrate B is conveyed to a downstream side so as to bypass the electrode forming device 1A and is arranged in parallel with the electrode forming device 1A (the same applies to the bypass conveyor C23).

The conveyor device 31 illustrated in FIG. 9 is arranged at a downstream side of the loader L. The conveyor device 31 is a device which assigns the substrate B conveyed from the loader L to either one of the import conveyor C11 and the bypass conveyor C13.

A “bypass unit” which conveys the substrate B to one electrode forming device and conveys the substrate B so as to bypass the other electrode forming device is structured to include the conveyor devices 31, 32, 33 and the bypass conveyors C13, C23.

The conveyor device 31 has a conveyor C31 which can convey the substrate B in a right-left direction in FIG. 9 and a conveyor unit (not shown) which conveys the conveyor C31 in an up-down direction in FIG. 9.

The conveyor unit (not shown) is, for example, a ball screw mechanism and conveys the conveyor C31 to a position adjacent to the import conveyor C11 or adjacent to the bypass conveyor C13.

The conveyor C31 receives the substrate B from the loader L, and then, conveys the substrate B to either one of the import conveyor C11 or the bypass conveyor C13 which are arranged at the downstream side of the conveyor C31. The structures of the conveyor devices 32, 33 are the same as that of the first conveyor device, and the explanation thereof will be omitted.

Time required for processing one substrate B in the electrode forming devices 1A, 1B and the inspection/repair device R is, for example, as follows. Processing time of the electrode forming device 1A (1B) is an amount value of time required for applying the flux, moving the mask member 15 and filling the conductive balls.

| Electrode forming | Electrode forming | Inspection/repair |
|---|---|---|
| device 1A | device 1B | device R |
| 60 seconds/piece | 60 seconds/piece | 30 seconds/piece |

Thus, processes in the electrode forming devices 1A, 1B take twice the time compared with a process in the inspection/repair device R arranged at the downstream side. Then, the electrode forming system S is operated with the conveyor devices 31, 32, 33 and the bypass conveyors C13, C23 as follows such that the inspection/repair device R can run full operation.

In the explanation below, the import conveyors C11, C21 are used for standby position of the substrate B. Thus, waiting time during which the substrate B is conveyed to the downstream side and a next substrate B is processed can be shortened.

### <Operation of the Electrode Forming System>

The electrode forming device 1A executes the flux application process and the conductive ball filling process sequentially as described above.

The conveyor device 31 conveys a new substrate B to either one of the electrode forming devices 1A, 1B which faster completes the ball filling process for the substrate B currently processed.

In case that the electrode forming device 1A completes the ball filling process faster, the conveyor device 31 conveys the substrate B to the import conveyor C11 (see the arrow indicated by the thick line in FIG. 9). The substrate B is conveyed to the electrode forming device 1A via the import conveyor C11. Further, after the electrode forming device 1A executes the flux application process and the ball filling process sequentially, the substrate B is conveyed to the inspection/repair device R via the bypass conveyor C23 and the conveyor device 33.

On the other hand, in case that the electrode forming device 1B completes the ball filling process faster, the conveyor device 31 conveys the substrate B to the bypass conveyor C13 (see the arrow indicated by the broken line in FIG. 9). The substrate B is conveyed to the conveyor device 32 via the bypass conveyor C13. Further, after the electrode forming device 1B executes the flux application process and the ball filling process sequentially, the substrate B is conveyed to the inspection/repair device R via the conveyor device 33.

While the substrate B is being conveyed, the electrode forming devices 1A, 1B incessantly execute the flux application process and the conductive ball filling process, and the substrate B to be processed next waits at the upstream side thereof (in short, the import conveyors C11, C21).

### <Effect>

According to the electrode forming system S of the embodiment, even when the processing time (60 seconds) of the electrode forming devices 1A, 1B is longer than the processing time (30 seconds) of the inspection/repair device R, the substrate B can be processed smoothly. In other words, the electrode forming devices 1A, 1B can continue to process incessantly by using the bypass conveyors C13, C23 as if passing lanes of the substrate B.

For example, the embodiment can shorten the time required for a series of processes to half compared with an electrode forming system having one flux printer and one ball printer arranged at a downstream side thereof. The electrode forming system S of the embodiment can improve process efficiency, in addition to a yield rate of the processed substrate B.

### <<Modification>>

The electrode forming device 1 and the electrode forming system S according to the invention are explained above, but the invention is not limited to the above embodiments and can be modified within the scope of the invention suitably.

For example, in each embodiment, partitioning the mask 151 (see FIG. 3) by the plate frame 152 into the first mask section 151a and the second mask section 151b is explained, but is not limited thereto. In other words, a structure may be employed, in which a mask for flux application corresponding to the first mask section 151a and the other mask for conductive ball filling corresponding to the second mask section 151b are connected to each other. In this case, each mask is connected and the periphery thereof is fixed by the plate frame 152 (see FIG. 3).

Also, in each embodiment, bringing the pressing plate 13 in surface contact with the substrate B is explained, but is not limited thereto. For example, the lower surface of the pressing plate 13 may be formed in a concave-convex shape such that the surface (lower surface) of the pressing plate 13 on which the substrate B is pressed does not contact on the electrodes of the substrate B. Thus, impurities cannot be attached on the electrodes in the substrate B due to contact with the pressing plate 13.

Further, in each embodiment, moving the mask member 15 with the filling head 17 by the motor M3 and the like (see FIG. 5) is explained, but is not limited thereto. For example, the mask member 15 may be moved with the squeegee head 16 using the motor M2 and the like which moves the squeegee head 16.

Also, the mask member 15 may be moved by a mechanism which is independent from the structure (motors M2, M3 and the like: see FIG. 5) which moves the squeegee head 16 and the filling head 17.

Still further, in each embodiment, the air cylinder 18 connected to the cover c of the filling head 17 is explained, but is not limited thereto. For example, even if the air cylinder 18 is arranged in the casing 17c, the mask member 15 can be moved with the filling head 17 in the X-direction (see FIG. 5).

Yet further, in each embodiment, adjusting the relative position of the mask member 15 to the substrate B is explained, but is not limited thereto. For example, an electromagnet or a robot arm (relative position fixing unit) may be used in place of the air cylinder 18.

Moreover, in the second embodiment, arranging the two electrode forming devices 1A, 1B in series is explained, but is not limited thereto. In other words, three or more electrode forming devices 1 may be arranged in series and a bypass conveyor may be provided in each electrode forming device 1.

The number of electrode forming devices 1 is preferably set based on a ratio of the processing time of the electrode forming device and the processing time of the other devices (such as the inspection/repair device R).

What is claimed is:

1. An electrode forming device comprising:
a pressing unit that presses a substrate on a printing table from above;
a suction unit that sucks the substrate pressed by the pressing unit on the printing table and continues to suck the substrate after the pressing unit is released;
a mask member that has a first mask section used for applying flux on the substrate and a second mask section used for filling a conductive ball on the substrate applied with the flux, the first mask section and the second mask section being connected to each other or being integrally formed;
a squeegee head that applies the flux via the first mask section on the substrate sucked by the suction unit;
a mask member moving unit that moves the mask member to adjust a relative position of the mask member to the substrate; and
a filling head that fills a conductive ball via the second mask section of the mask member to form an electrode on the substrate sucked by the suction unit.

2. The electrode forming device according to claim 1 further comprising a camera moving unit that moves a camera used for aligning the mask member and the substrate, wherein the camera moving unit moves the pressing unit with the camera.

3. The electrode forming device according to claim 1, wherein the mask member moving unit comprises a head moving unit that moves a head as the squeegee head or the filling head and a relative position fixing unit that fixes a relative position of the mask member and the head, and the head moving unit moves the mask member of which the relative position to the head is fixed by the relative position fixing unit with the head.

4. The electrode forming device according to claim 1, wherein the pressing unit has a surface formed in a concave-convex shape that faces the substrate so as not to contact on a preformed electrode of the substrate when the substrate is pressed.

5. An electrode forming system comprising a plurality of electrode forming devices as set forth in either one of claims 1 to 4, and a bypass unit that conveys a substrate in one of the electrode forming devices and conveys the substrate so as to bypass the other electrode forming device, wherein the plurality of electrode forming devices are arranged in series.

6. An electrode forming method comprising:
pressing a substrate on a printing table by a pressing unit from above;
sucking the substrate pressed by the pressing unit on the printing table by a suction unit and continuing to suck the substrate after the pressing unit is released;
applying flux by a squeegee head on the substrate via a first mask section of a mask member in which a first mask section for applying the flux on the substrate and a second mask section for filling a conductive ball on the substrate applied with the flux are connected to each other or integrally formed;
moving the mask member applied with the flux by the mask member moving unit and adjusting positionally a relative position of the mask member to the substrate; and
filling a conductive ball via the second mask section of the mask member by a filling head to form an electrode on the substrate sucked by the suction unit.
